(19) United States
(12) Patent Application Publication
(10) Pub. No.: US 2014/0081673 A1
(43) Pub. Date: Mar. 20, 2014

(54) TITLE DOCUMENT RULES ENGINE METHOD AND APPARATUS

(71) Applicant: Michael A. Batchelor, Carmel, IN (US)

(72) Inventor: Michael A. Batchelor, Carmel, IN (US)

(73) Assignee: INSURANCE AUTO AUCTIONS, INC., Westchester, IL (US)

(21) Appl. No.: 14/028,944

(22) Filed: Sep. 17, 2013

Related U.S. Application Data
(60) Provisional application No. 61/702,309, filed on Sep. 18, 2012.

(51) Int. Cl. G06Q 40/08; G06Q 10/06

(52) U.S. Cl. CPC G06Q 40/08; G06Q 10/063114
USPC 705/4

(57) ABSTRACT

A method and apparatus for tracking and guiding the transfer of a vehicle includes determining which documents and things are required in the title transfer process. Documents needed in the title transfer process are generated by the system. The guiding, tracking and documents are specific to each situation depending on state in which the vehicle is titled, state in which the vehicle is being sold, insurance company that insured the damaged vehicle, etc.

### CROSS-REFERENCE TO RELATED APPLICATION

This application claims the benefit of U.S. Provisional Patent Application Ser. No. 61/702,309, filed Sep. 18, 2012, which is incorporated herein by reference.

### BACKGROUND OF THE INVENTION

1. Field of the Invention

The present invention relates generally to a method and apparatus for guiding the workflow for transferring the ownership of a vehicle and for generating the documents used in the process, and more particularly to an automated system to tracking and guiding the transfer of vehicle title documents of a vehicle that has been damaged and determined to be a total loss and which may be sold for its salvage value.

2. Description of the Related Art

When an automobile or other vehicle is damaged, for example in an accident or natural disaster, a determination is made as to whether repair of the vehicle is economically feasible. If the cost of repair is great relative to the value of the vehicle, the damaged vehicle may be determined to be a total loss (totaled) rather than having the damaged vehicle repaired for continued use by the owner. Typically, an insurance company that insures the vehicle which is determined to be a total loss takes ownership of the damaged vehicle as part of the insurance claim settlement with the vehicle owner. The insurance company generally sells the damaged vehicle for its salvage value.

In particular, when a vehicle is declared a total loss, the insurance company takes ownership of the vehicle by issuing a payment in the amount of the actual cash value (ACV) of the vehicle to the vehicle owner and any lien holder in exchange for a properly executed title for the vehicle. The title must be signed by the owner and any existing liens must be released by the lien holder. Upon receipt of the title, the insurance company takes legal ownership of the vehicle by transferring the title to the insurance company's name and branding the title as salvage per the regulations of the state where the vehicle is being sold. Once this process is complete the vehicle is sold (typically by a salvage vehicle auction) to a buyer who is legally entitled to purchase salvage vehicles.

The specific process and required documentation differs in each situation and is determined by several factors including:
The number of owners listed on the title of the vehicle
The state in which the vehicle is titled
The state in which the vehicle is being sold
Whether or not a lien exists on the vehicle
Whether or not the owner owes more to the lien holder than the vehicle is worth (commonly referred to as “upside-down”)
Whether the owner is deceased
Whether the owner is retaining the vehicle or releasing it to the insurance company
Whether the vehicle was damaged or stolen

The process of paying off the lien, receiving the title, and paying the owner and lien holder is usually executed remotely and documents (i.e. titles, powers of attorney, checks and lien releases) are typically exchanged via US mail or an express delivery service. A proper exchange requires careful coordination between the:
Insurance company,
Vehicle owner,
Lien holder,
Salvage auction entity, and
State motor vehicle department.

This coordination must be very carefully orchestrated to ensure that each party receives appropriate and complete documentation in a timely fashion. The number of variables in this process combined with the complication of having to execute this process remotely by exchanging paper documentation via mail or express delivery often results in process exceptions such as missing or improperly executed documentation. These process exceptions prevent insurance companies from legally transferring and branding vehicle titles and lead to costly remediation and delays in selling these vehicles.

Multiply this process by the number of vehicles involved and the magnitude of the problem becomes evident. Every year insurance companies in the United States declare more than three million damaged and stolen vehicles as total losses.

Historically, insurance companies have acted as the central point of contact for all of the entities involved. They have collected all documentation from and issued payment to owners and lien holders, then have submitted all documentation to a salvage auction who then submitted the title to the state motor vehicle department for transfer and branding. A significant problem with this model is that it allows for layers of communication between the entity obtaining the documentation and the state agency that is validating the documentation. This means that when the state rejects a document, then the salvage auction must inform the insurance company, and the insurance company must procure new documents. This incurs expense and costs valuable time, and when the process becomes delayed for too long of a time, the result is often that proper documentation becomes impossible to obtain and the vehicle must then be abandoned.

### SUMMARY OF THE INVENTION

The present invention provides an integrated workflow guiding system and document generating system to provide a method and apparatus that tracks the workflows involved in acquiring and processing ownership documents for vehicles and that generates many of the necessary documents used in the process. The present method and apparatus can be used by a service provider that provides title acquisition and management services to those involved in the processing of damaged vehicles. For example, insurance companies may utilize the service provider to handle the transfer of the vehicle titles for vehicles deemed to be a total loss.

Although the present workflow monitoring and document generating system and method can be used for ownership documents of other items than vehicles and can be used for vehicles for other purposes, the preferred embodiment is used for workflows associated with acquiring and transferring ownership of damaged vehicles for salvage.

The processing of the vehicle transfer documents can be performed by a service provider outside the insurance company. According to this embodiment, the method and apparatus provides a bridge across the gap between an insurance company and a state motor vehicle department using a title management process driven by a title document rules engine.

In one aspect of the invention, the present method and apparatus offers insurance providers a service described as full service title management. This service allows insurance companies to outsource the process of settlement document generation and execution to an outside company.

In one embodiment, a computer executed method monitors the steps in a vehicle ownership transfer process. A computer system that is programmed to perform the method determines what documents are required for the particular vehicle transfer, what steps will be necessary, and what parties will need to be contacted. The computer executed method monitors the steps and tracks those steps that have been completed and those that still need to be completed. In some embodiments, the computer executed method and apparatus prepares the necessary forms and documents for the particular ownership transfer situation. The preparation of the required forms can be automatic or triggered by an event or by a user command.

### BRIEF DESCRIPTION OF THE DRAWINGS

FIG. 1 is a block diagram showing process steps in an insurance claim settlement and vehicle procurement process that uses a document generating engine according to the principles of the present invention; and

FIG. 2 is a functional block diagram of a system including a document generating engine according to the principles of the present method.

### DETAILED DESCRIPTION OF THE PREFERRED EMBODIMENTS

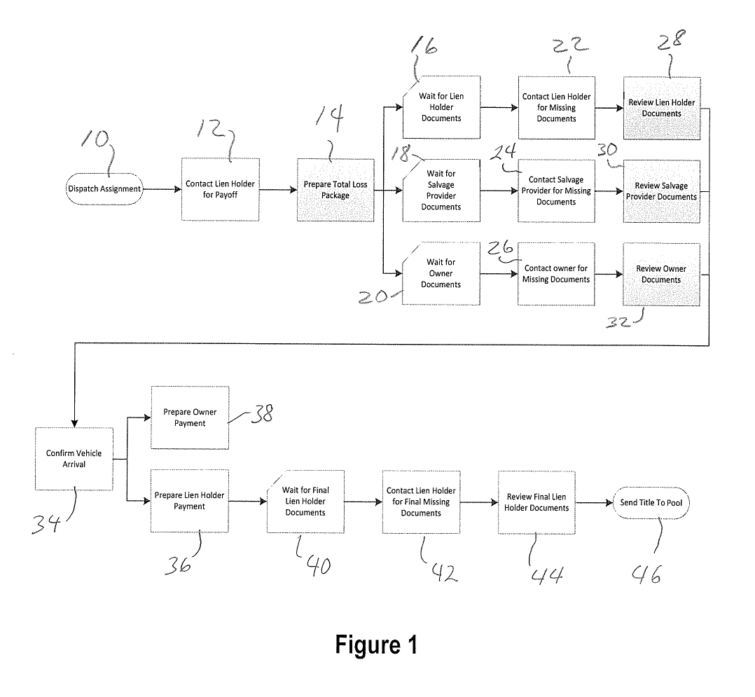

As shown in the block diagram of FIG. 1, the title management and document generation method and apparatus of a preferred embodiment executes the process steps illustrated. At a very high level this process may involve the illustrated steps.

In a step 10 of receiving an assignment (also referred to as dispatch assignment as shown in the first block of FIG. 1), a report of a damaged vehicle is received and entered into the system. In a preferred embodiment, the information is received by a service provider that provides the service of overseeing the transfer of the vehicle title documents on behalf of an insurance company or other entity. It is also possible that the entity performing the steps of this process could be a department within the insurance company, a department within a salvage company, or some other entity, Information received for entering may include identifying information for the vehicle, state where the vehicle is titled, state where the vehicle will be sold, identity of the insurance company that is insuring the vehicle, and may include other information.

In a step 12 of contacting the lien holder for payoff amount as shown in the second block, a determination is made as to whether there is an outstanding loan on the damaged vehicle or if there are other liens on the vehicle. Any lien holder for the damaged vehicle is contacted and the balance due on the loan or other financial instrument is determined.

As indicated by the third block 14 in FIG. 1, a total loss package is prepared. This includes generating a package of documentation for the owner and lien holder to execute so that the insurance company can take ownership of the vehicle and sell the vehicle. A list of the required documents and other items for the specific situation is automatically generated by the system. The documents can be generated by the user of the system entering a command approving the generation of the documents, or some or even all of the needed documents may be automatically generated by the system. Since each titling state, each insurance company, and each selling state can have different document requirement, the information is customized at this step to the particulars of the situation. Any documents that are generated, either automatically or at the instruction of the user, are delivered to the respective parties, such as by the user of the system. It is foreseeable that documents generated by the system may also be automatically forwarded to the parties.

In following steps, the process splits and indicates that the documents that were delivered to the parties and/or that were requested from the parties, are to be forwarded to the processor as next steps in the process. The three next blocks in FIG. 1 indicate that the system awaits the return of those documents. In particular, the system waits for owner documents from the vehicle owner at block 16, such as a title that has been executed for transfer. The system also awaits return of the lien holder documents, if any, at block 18, and waits for documents from a salvage provider at block 20. If the desired documents are not returned within predetermined times, the system includes reminders to contact the owner at block 22, lien holder at block 24, and salvage provider at block 26 for any missing documents. The system may notify a user to make the contact or may automatically generate the contact.

Each of the documents sets that are received from the parties are reviewed, such as for accuracy and completeness, as indicated by next blocks in FIG. 1. In particular, at block 28, the documents received from lien holder are reviewed, at block 30, the documents received from the salvage provider are reviewed, and at block 32, the documents received from the vehicle owner are reviewed. The review may be assisted by the system in that the reviewer person or persons are instructed as to what information must be on each form and what documents must be received. The review of the documents may also be by automated review, where the system receives the documents in electronic form or has the documents input as electronic documents and performs the review. In particular, the lien holder documents (if any) are reviewed at 28, as are the salvage provider documents at 30 and the owner documents at 32. The system determines whether the correct information, signatures and the like have been provided on the correct documents. Corrections may be made during this step, such as obtaining corrected documents or acquiring missing documents.

The next step 34 provides that the vehicle is received by a receiving party. After receipt of the vehicle, the owner payment is prepared and sent to the owner at block 36. The lien holder payment is also prepared and sent to the lien holder, if any, at block 38. After the lien holder receives payment, the lien holder forwards the final papers on the lien to the processor, as indicated by the block 40 designated wait for final lien holder documents. If any lien documents are missing, the lien holder is contacted and requested to send the missing documents, as indicated by the following block 42. The final lien holder documents are reviewed at block 44 and if found complete the vehicle title is forwarded to a pool of vehicles to be sold at auction for salvage, as indicated by block 46. Any or all of the forgoing steps may be guided and tracked by the system.

A title document rules engine is provided as a component of the preferred embodiment of the system. The blocks 14, 28, 30 and 32 in FIG. 1 that are shaded indicate the process steps that are specifically governed by the title document rules engine; specifically the generation and validation of documentation. This process and the proposed mechanism for automating this process are detailed in the next section.

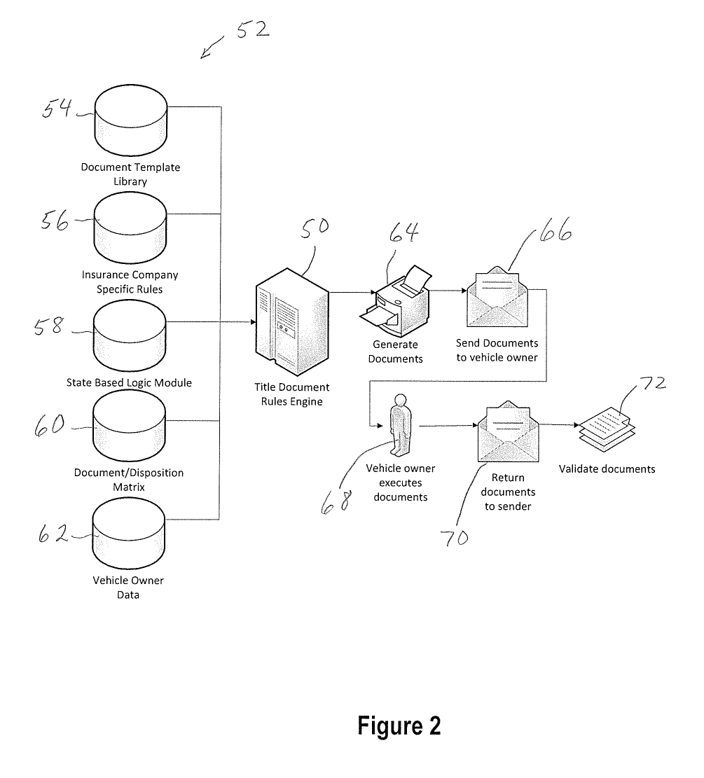

As shown in FIG. 2, the title document rules engine (TDRE) includes a computer device such as a computer server 50 connected to several data storage sections, devices or locations 52 which serve as a repository of the documents that are used in the settlement of a total loss situation of a damaged vehicle and a subsequent transfer of the title of that vehicle into a salvage title in the insurance company's name. The title document rules engine 50 can be provided by a single server device, as multiple servers, one or more computer devices or other programmable devices having one or more processors for executing a program stored on computer readable media. The data storage 52 can be a single data storage device including computer readable data storage media, or can be multiple data storage devices or can be data stored in the cloud. The title document rules engine server 52 may be connected via a network connection, such as the internet or a private network, to one or more computer devices, including desktop computers, laptop computers, notebook computers, tablet computers, PDAs, smart phones, or other user interface device. The user may instead interact directly with the server.

The TDRE also contains a matrix for each state and insurance customer that matches the correct documents to each of the following situations:
A vehicle being sold at auction with a lien
A vehicle being sold at auction with an upside-down lien
A vehicle being sold at auction without a lien
A vehicle being retained by the owner with a lien
A vehicle being retained by the owner with an upside-down lien
A vehicle being retained by the owner without a lien
A vehicle that was stolen and not recovered with a lien
A vehicle that was stolen and not recovered with an upside-down lien
A vehicle that was stolen and not recovered without a lien

The TDRE allows the user to automate the process of generating accurate settlement packages for insurance companies. Use of the TDRE dramatically reduces the cost and improves the accuracy of the title transfer process, resulting in fewer costly errors for insurance company customers of the service provider, or for others.

The TDRE draws upon multiple proprietary information sources as indicated by the data storage symbols, including but not limited to:

Document Template Library 54—A library of document templates that are dynamically generated as filled out documents when a settlement package is generated. Documents may include settlement letters, powers of attorney, process instructions, etc.

Insurance Company Specific Rules library 56—A listing of insurance company specific processing rules for each insurance company that the user will deal with.

State Based Logic Module 58—A compendium of motor vehicle department information including contact information, processing times, fees, alternate disposal procedures, etc. The state motor vehicle department information is preferably all states, but should at least cover the states in which the vehicles are insured and/or in which the vehicles will be sold.

Document/Disposition Matrix 60—A list of required documents in each state associated with each vehicle disposition. This matrix may, for example, specify that in the state of Alaska if XYZ Insurance Company is sending a car to auction and the owner has a lien on the vehicle then the system identifies a set of documents and information needed for the transfer as set forth in Table 1, below. These are the documents that the system generates or are documents and things that the system indicates that are needed and that the system is expecting. Of course, other states, other insurance companies, and other situations will require different documents and things.

Work Order Data 62—Also referred to as vehicle owner data. This is data that is specific to a given work order. It includes information about the owner, the vehicle, the location of the vehicle, the state that the vehicle is titled in, and process information. Data elements may include: assignment date, owner contact information, vehicle description information and comments that have been collected about the work order.

As noted above, the following table is the list of required documents and things for a vehicle transfer in the state of Alaska when the vehicle is subject to a lien. The system generates the list for each reported damaged vehicle such that the list is specific to the state and situation. In the preferred embodiment, the system may also generate at least some of the documents themselves.

TABLE 1
Documents for Vehicle Transfer in Alaska

| Party | Documents |
|---|---|
| To Vehicle Owner | Settlement check |
| | Odometer disclosure |
| | Instructions on how to sign the title |
| | A registration request disclaimer |
| From Vehicle Owner | Signed title |
| | Odometer disclosure |
| | Copy of vehicle registration |
| To Lien Holder | Lien holder check |
| | Request for Letter of guarantee |
| | Request for copy of title |
| From Lien Holder | Copy of title |
| | Original Title |
| | Letter of guarantee |
| To Insurer | Check request |
| From Insurer | Lien holder check |
| | Owner check |

Items in bold are generated by the system. Items not in bold are external to the system.

### Title Document Rules Engine Workflow

The workflow for one example of the process proceeds as follows:

In a first step, the insurance adjuster provides the company or other user with several key data elements concerning a damaged vehicle, including:
a. The insurance company information for the company covering the vehicle
b. Vehicle owner contact information
c. The state where the damaged vehicle is being sold
d. The state where the vehicle is currently titled
e. The lien status of the vehicle and lien payoff amount if an active lien exists
f. The Actual Cash Value (ACV) of the vehicle
g. The repair estimate for repair of the damage to the vehicle
h. The year, make and model of the vehicle

Next, the Title Document Rules Engine 50 uses all of these items in conjunction with the Document/Disposition Matrix 60 and the Insurance Company Specific Rules Repository 56 to determine which documents to generate, and to determine which documents are expected back.

A company employee or other user will review the list of documents identified by the TDRE 50 (specifically the Document Template Library 54, the Vehicle Owner Data 62 and the State Based Logic Module 58), modify the list if necessary then generate the documents, as shown at 64, in print or as an electronic document that can be electronically signed (refer to the example of Table 1). The system may generate some or all of the user originating documents automatically. Of course, documents such as the title from the owner or the payment from the insurance company would not be generated by the system, but would be tracked by the system.

The company employee will distribute these documents, as shown at 66, to the appropriate party (i.e. to the vehicle owner or to the lien holder). It is foreseen that the system can be used to electronically distribute the documents, such as by automatically generating letters and emails.

When the documents have been are executed, as indicated at 68, and returned, as indicated at 70, they will be scanned into electronic form (if in print), reviewed and approved, as indicated at 72, in the Documentation Management System. Electronic documents can be directly input into the system for review.

The TDRE device 50 is operable to evaluate the documents it has received to determine what documents have been received and to determine if the documents include the necessary information. The Document Disposition Matrix portion 60 of the system is operable to determine if all of the required documents were received. If all of the expected documents have not been received, the system will notify the user that additional documents are expected. If all of the expected documents have been received, the system will move the work order to the next workflow step as dictated by the assignment type.

Thus, there is shown and described a method and apparatus for tracking transfer of ownership of a damaged vehicle and for generating documents for use in the transfer of the vehicle ownership. The chance of errors and delays in the title transfer process is decreased. A service provider using the present method and apparatus may provide title transfer services to an insurance company or other entity.

Although other modifications and changes may be suggested by those skilled in the art, it is the intention of the inventors to embody within the patent warranted hereon all changes and modifications as reasonably and properly come within the scope of their contribution to the art.

We claim:

1. A method for tracking a transfer of ownership of a damaged vehicle, comprising:
receiving information regarding a damaged vehicle;
receiving information regarding an insurance company that insures the damaged vehicle;
receiving information regarding a state of title for the damaged vehicle;
in a programmed computer, automatically generating a task list of tasks specific to the vehicle and the insurance company and the state, the tasks being required tasks for transfer to the title of the damaged vehicle;
in a programmed computer, tracking completion of the tasks on the task list.

2. A method as claimed in claim 1, further comprising:
in a programmed computer, automatically generating a document required for transfer of ownership of the damaged vehicle.

3. A method as claimed in claim 2, further comprising:
in a programmed computer, automatically transmitting the automatically generated document to an entity for completion.

4. A method as claimed in claim 1, further comprising:
in a programmed computer, receiving a completed document relating to transfer of the vehicle; and
in a programmed computer, automatically reviewing the completed document for compliance.

5. A method as claimed in claim 1, wherein the task list includes tasks to obtain documents from a lien holder, and tasks to obtain documents from a salvage provider, and tasks to obtain documents from an owner of the damaged vehicle.

6. A method as claimed in claim 5, further comprising:
in a programmed computer, automatically generating a document for a lien holder, automatically generating a document for a salvage provider, and automatically generating a document for an owner of the damaged vehicle.

7. A method as claimed in claim 1, further comprising:
in a programmed computer, accessing a document template library, accessing an insurance company specific rules database, accessing a state based logic module, accessing a document disposition matrix, and accessing vehicle owner data.

8. An apparatus for tracking a transfer of ownership of a damaged vehicle, comprising:
a computer device including a processor for executing a program to perform a document generating function; and at least one of the following:
a document template library,
insurance company specific rules,
state based logic module,
document/disposition matrix, and
vehicle owner data,
wherein the computer device is operable to generate a task list of tasks required to affect a transfer of a vehicle title and is operable to monitor completion of tasks on the task list.
